(19) United States
(12) Patent Application Publication
(10) Pub. No.: US 2011/0078101 A1
(43) Pub. Date: Mar. 31, 2011

(54) RECOMMENDING ONE OR MORE EXISTING NOTES RELATED TO A CURRENT ANALYTIC ACTIVITY OF A USER

(75) Inventors: David H. Gotz, Purdys, NY (US); Yedendra B. Shrinivasan, Eindhoven (NL)

(73) Assignee: INTERNATIONAL BUSINESS MACHINES CORPORATION, Armonk, NY (US)

(21) Appl. No.: 12/566,987

(22) Filed: Sep. 25, 2009

(51) Int. Cl. G06N 5/02; G06F 3/00

(52) U.S. Cl. 706/46; 715/700

(57) ABSTRACT

Methods and apparatus are provided for recommending one or more existing notes related to a current analytic activity of a user. One or more existing notes related to a current analytic activity of a user are recommended by maintaining a logical record of analytic activity of the user by recording one or more visual analytic actions performed by a user; generating a context model for a plurality of the existing notes, wherein the context model for a given existing note represents information interests of the user; determining a relevance score for each of the plurality of existing notes, wherein a given relevance score characterizes a relevance of a corresponding existing note to the current analytic activity; and recommending one or more existing notes based on the determined relevance scores. The context model for the given existing note represents the information interests of the user at a time surrounding the point when the user recorded the corresponding existing note.

### FIELD OF THE INVENTION

The present invention relates to data analysis tools and, more particularly, to techniques for retrieving views, notes and concepts from past data analyses of a user that are related to a current view or note.

### BACKGROUND OF THE INVENTION

Business users are creating and storing more data than ever before. Recognizing that valuable insights are contained in this information, companies have begun to encourage the use of visualization to drive their business decision-making processes. Moreover, companies want to empower all of their employees to take part in such a process. A number of applications exist to help users view, explore, and analyze information.

Interactive visualizations allow users to investigate various characteristics of a dataset and to reason based on patterns, trends and outliers. During complex visual analyses, users must derive insights by connecting discoveries made at different stages of an investigation. However, during a long investigation process that can span hours, days or even weeks, it becomes difficult for users to recall the details of their past discoveries. Yet these details may form the key connections between their past work and current line of inquiry. The difficulty in recalling past work often leads users to overlook important connections. The challenge, therefore, is to develop techniques that assist in “connecting the dots” by uncovering connections to users' past work that would normally go unnoticed.

To address the challenge of recalling past work, users often externalize interesting findings or new hypotheses using either annotations on top of visualizations or through bookmarks in electronic notes. These notes help users to manually revisit and review their past analysis. However, as the number of notes and annotations grows larger, users again have difficulty recalling the details of each previous discovery.

A need therefore exists for users to be able to more easily retrieve related views, notes and concepts (including data characteristics investigated in the views and entities from notes) from their past analyses. These related views, notes and concepts can then help them to find interesting connections within their analysis. A further need exists for a context-based retrieval algorithm that retrieves views, notes and concepts from users' past analysis related to a view or a note based on their line of inquiry.

### SUMMARY OF THE INVENTION

Generally, methods and apparatus are provided for recommending one or more existing notes related to a current analytic activity of a user. According to one aspect of the invention, one or more existing notes related to a current analytic activity of a user are recommended by maintaining a logical record of analytic activity of the user by recording one or to more visual analytic actions performed by a user; generating a context model for a plurality of the existing notes, wherein the context model for a given existing note represents information interests of the user; determining a relevance score for each of the plurality of existing notes, wherein a given relevance score characterizes a relevance of a corresponding existing note to the current analytic activity; and recommending one or more existing notes based on the determined relevance scores.

The relevance score for a given existing note is based on the context model for the given existing note and a context model for the current analytic activity. The context model for the given existing note represents the information interests of the user at a time surrounding the point when the user recorded the corresponding existing note.

The context model can be represented as a weighted set of action concepts. The relevance score is based on one or more of a specificity of the action concepts and a logical recency of the action concepts. The weighted set of action concepts can be extracted from the analytic activity of the user by spreading activation over a representation of the analytic activity of the user.

In one exemplary embodiment, the weight W_{c} for a given action concept c is computed as follows:

$${W}_{c} = {s}_{c} \times ( {w}_{b} \times {\sum }_{i = 1}^{b} {d}_{i} + {w}_{f} \times {\sum }_{i = 1}^{f} {d}_{i} ) \qquad ( 1 )$$

where s_{c} is a specificity weight of the action concept c; b and f are lengths of back and forward traces, respectively; w_{b} and w_{f} are weights for the forward and back traces; and dᵢ is a normalized distance of an exploration action (i) from an end of a trace for a current view or note. The relevance score d(T) for the existing note (T) is computed as follows:

$$d ( T ) = {\sum }_{i = 1}^{m} ( {W}_{B} ( {c}_{i} ) \times {W}_{T} ( {c}_{i} ) ) + {\sum }_{i = 1}^{p} ( {w}_{B} ( {e}_{i} ) \times {w}_{T} ( {e}_{i} ) ) \qquad ( 2 )$$

where m is a number of related action concepts and p is a number of entities from a base note.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of a context-based retrieval system incorporating features of the present invention;

FIG. 2 is an exemplary graphical user interface illustrating a number of exemplary user interaction areas;

FIG. 3 shows a portion of an action trail for an exemplary analyst investigating product sales data; and

FIG. 4 is a flow chart describing an exemplary related notes recommendation process incorporating features of the present invention.

### DETAILED DESCRIPTION OF PREFERRED EMBODIMENTS

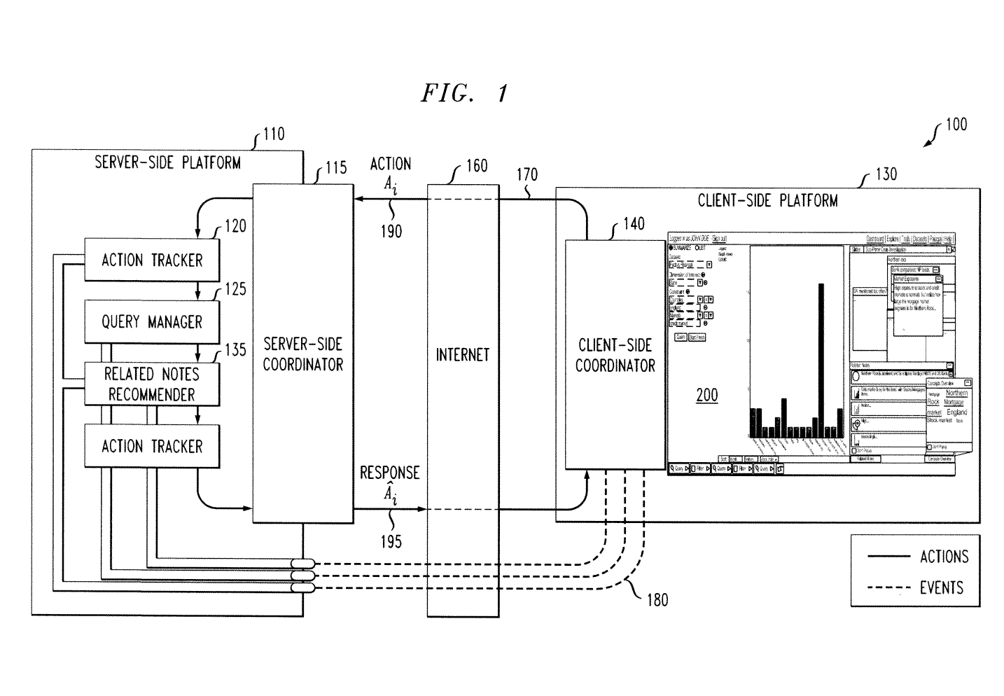

The present invention provides a context-based retrieval system 100, shown in FIG. 1, that retrieves views, notes and concepts from users' past analysis related to a view or a note based on their line of inquiry. Whenever a user creates a view or records a note, a context description is derived for the view or note from the user's line of inquiry. The context descriptions are used to retrieve the most relevant views, notes and concepts from past analyses. As users create new views during their analysis, the disclosed context-based retrieval system 100 dynamically recommends the most relevant notes from past analyses. In one exemplary embodiment, an overview of related notes is presented as a ranked list of notes along with a thumbnail of associated views in the note-taking interface. An overview of related concepts is also optionally shown using a tag cloud. Both overviews can be updated after each exploration action.

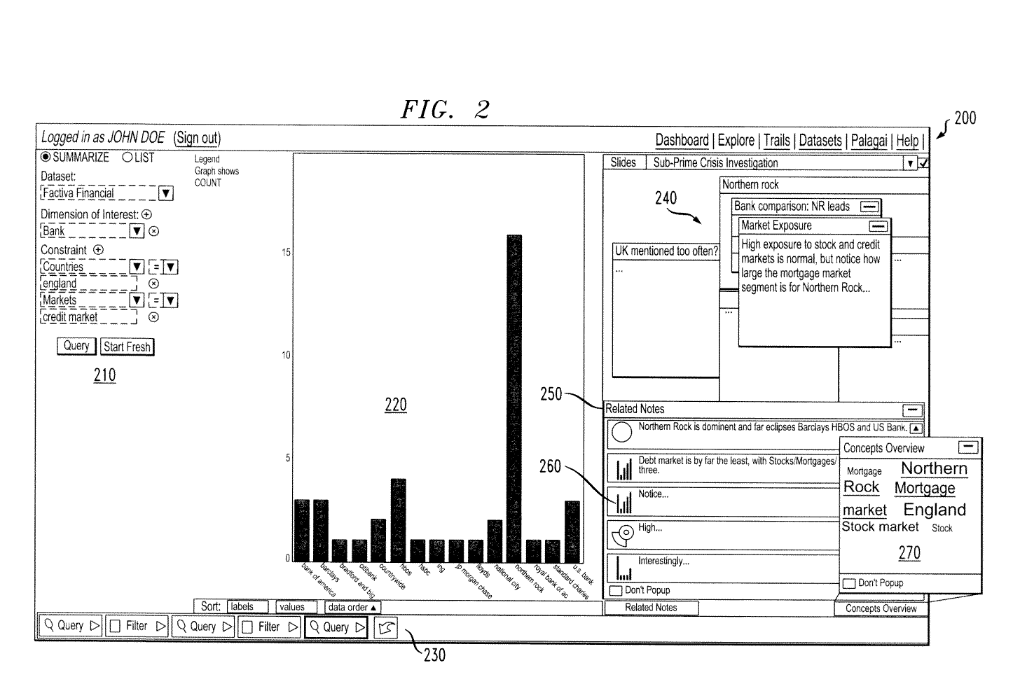

FIG. 1 is a block diagram of an exemplary context-based retrieval system 100 incorporating features of the present invention. As shown in FIG. 1, the exemplary context-based retrieval system 100 comprises a server side platform 110 and a client side platform 130. It is noted that a client-based implementation is also within the scope of the present invention. The server side platform 110 contains a server side coordinator 115, as well as an action tracker 120, a query manager 125, and a related notes recommender 135. The client side platform 130 contains a client side coordinator 140. The exemplary server side platform 110 and client side platform 130 communicate over a network such as, for example, the Internet 160. For a more detailed discussion of exemplary server side platform 110, server side coordinator 115, a client side platform 130 and client side coordinator 140, see, for example, U.S. patent application Ser. No. 12/367,132, entitled “Methods and Apparatus for Intelligent Exploratory Visualization and Analysis,” incorporated by reference herein. The exemplary client side platform 130 employs a browser-based graphical user interface 200, discussed further below in conjunction with FIG. 2.

In one exemplary embodiment, given a user's input through the browser-based graphical user interface 200, a request is first routed to the client side coordinator 140. Depending on the type of user interaction, the coordinator 140 triggers one of two exemplary client-server communication paths in the context-based retrieval system 100: an action loop 170 or an event loop 180, as shown in FIG. 1. The exemplary action loop 170 is the primary client-server communication path in the exemplary context-based retrieval system 100. When an action reaches the server side platform 110, the exemplary action loop 170 involves the action tracker 120, query manager 125 and related notes recommender 135 within the server side platform 110.

Generally, the query manager 125 is responsible for interpreting and executing user queries for information (e.g., by translating to and executing SQL queries to databases). Once query results are obtained, the context-based retrieval system 100 then optionally selects the proper visualization to encode the retrieved data. Depending on the quality of the data, it may also decide to transform the data (e.g., normalization) for better visualization. Visualizations can be based, for example, on the teachings of U.S. patent application Ser. No. 12/194,657, entitled “Methods and Apparatus for Visual Recommendation Based on User Behavior,” incorporated by reference herein.

Once a visual response is created, it is then sent back to the client-side coordinator 140 to eventually update the visual canvas 200. The action tracker 120 observes and logs user actions 190 and the corresponding response 195 of the system 100. As discussed further below, the action tracker 120 records each incoming action 190 and parameters of key responses 195, such as action type, parameters, time of execution and position in sequence of performed actions. The action tracker 120 attempts to dynamically infer a user's higher-level semantic constructs (e.g., action patterns) from the recorded user actions to capture a user's insight provenance and assist in visualization recommendation. The action tracker 120 may be based, for example, on the teachings of U.S. patent application Ser. No. 12/198,964, entitled “Methods and Apparatus for Obtaining Visual Insight Provenance of a User,” incorporated by reference herein.

Connection Discovery

To support the connection discovery process in visual analysis, one aspect of the present invention enables users to retrieve views, notes and concepts from past analyses related to a view or note. When a user creates a view of his or her data or records a note, the context-based retrieval system 100 derives a context description for the view or note from their line of inquiry. The context descriptions are then used to retrieve the most relevant views and notes from past analyses. The context description is derived from a model of visual analytic activity called action trails. For a more detailed discussion of action trails, see U.S. patent application Ser. No. 12/367,132, entitled “Methods and Apparatus for Intelligent Exploratory Visualization and Analysis,” incorporated by reference herein.

Generally, action trails represent users' analytic activity as graphs of semantic analytic steps, or actions. Actions can be classified into broad categories: exploration actions, insight actions, and meta-actions. An exploration action alters the visualization specifications in a visual analytics system and creates a new view. Insight actions record or organize notes and views, while meta-actions (e.g., revisit, undo, redo) allow users to review and structure their lines of inquiry.

Action trails contain valuable information about the concepts that are most relevant to a user's analysis and how the user's interests evolve over time. A set of concepts are extracted from the action trail to form the context description for each view or note. In an exemplary implementation, two types of concepts are extracted. Action concepts are derived from the attributes associated with exploration actions (e.g., data and view parameters). Entities are concepts extracted from a user's notes and represent items such as people, places or companies.

As discussed hereinafter, for each concept associated with a view or note, a concept weight is derived from the user's action trail to determine its degree of salience at the time the view or note was created. For a view or note focused by the user, the relevance score is computed to existing views and notes by comparing the context descriptions of existing views and notes with that of the given view or note. Using the relevance score, the related views and notes are retrieved. An overview of the related concepts is also provided. Thus, the disclosed context-based retrieval algorithm surfaces the most relevant information from the past analyses of the users based on their line of inquiry during a visual analysis.

FIG. 2 is an exemplary graphical user interface 200 illustrating a number of exemplary user interaction areas. As shown in FIG. 2, the exemplary graphical user interface 200 provides a query panel 210 for issuing data queries, a visualization canvas 220 for displaying user-requested information, and a history panel 230 where a user can view and modify his or her ongoing exploration path, expressed as an action trail, discussed below. Each note has one or more associated action trails. For additional details on exemplary visualization types that can be employed in the visualization canvas 220, see U.S. patent application Ser. No. 12/194,657, entitled “Methods and Apparatus for Visual Recommendation Based on User Behavior,” incorporated by reference herein. For additional details on action trails that are presented in the history panel 230, see U.S. patent application Ser. No. 12/198,964, entitled “Methods and Apparatus for Obtaining Visual Insight Provenance of a User,” incorporated by reference herein.

The exemplary graphical user interface 200 also presents a list 250 of related notes along with thumbnails 260 of the view displayed while recording those notes related to the current view 220. A note-taking interface 240 allows a user to enter notes regarding the current view 220 and/or the analysis that led to the current view 220. The exemplary graphical user interface 200 also provides an overview 270 of related concepts using a tag cloud. A user can optionally click on a given concept in the overview 270 and follow a link to one or more corresponding locations in the notes 250 where the corresponding concept is discussed.

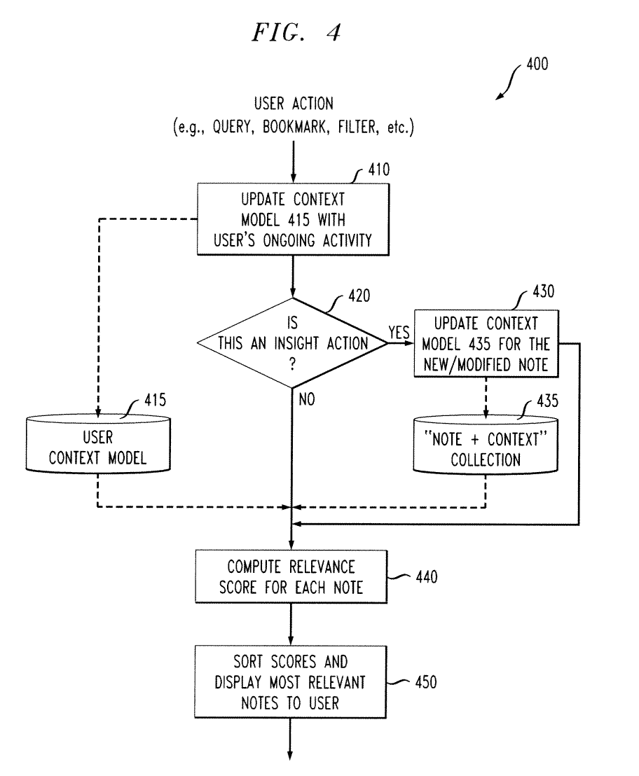

In this manner, the present invention presents related notes 250 through the note-taking interface 240. When a user records a note, the context-based retrieval system 100 augments the note with a context description. Then, as the user creates a new view, a related notes recommendation process 400, discussed further below in conjunction with FIG. 4, dynamically derives a context description for the view from the current action trail 230 and compares the derived context description with the context descriptions attached to the user's notes. Based on this comparison, the context-based retrieval system 100 computes a relevance to score for each note and presents a ranked list of related notes through the note-taking interface 240 (FIG. 2). A thumbnail 260 of the visualization that was displayed while the user originally recorded each note is also shown. An overview 270 of concepts extracted from notes (underlined) and views is optionally shown on-demand. With the note-taking interface 240, users can either explicitly request related notes 250 at any time or have the context-based retrieval system 100 automatically recommend them after each exploration action.

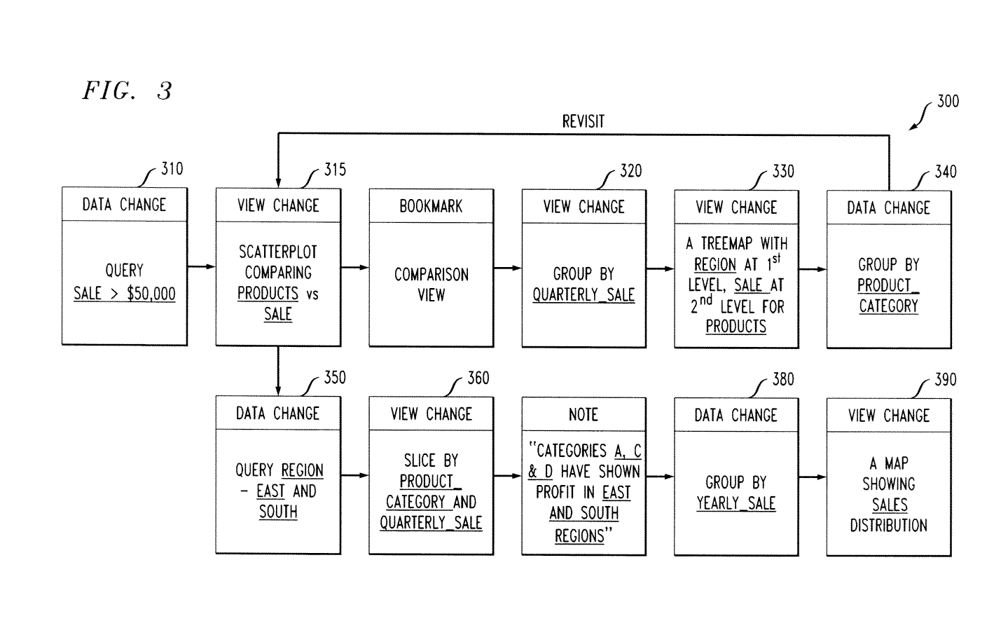

FIG. 3 shows a portion of an action trail 300 for an exemplary analyst investigating product sales data. The analyst starts his or her analysis by focusing on sales that are more than $50,000 at stage 310. The analyst compares sales of each product using a scatter plot visualization and creates a bookmark during stage 315. Then, the analyst studies quarterly sales of the products by aggregating the sales represented on the y-axis of the scatter plot based on a quarterly time period during stage 320. Next, the analyst uses a tree map to visualize the sale figures in various regions during stage 330. Further, the analyst clusters the products by their category to get an overview of the sales performance by product category in various regions during stage 340. This view triggers her to reconsider the products sales comparison that the analyst investigated some time back. The analyst therefore revisits the comparison view the analyst bookmarked earlier. Then the analyst narrows down to the east and south regions during stage 350. This revisit and reuse of a view creates a branch in her action trail.

The analyst further slices the products in the x-axis of the scatter plot by their category; and slices sales in the y-axis of the scatter plot by quarterly period during stage 360. This slicing creates a scatter plot matrix showing sales of various product categories in different quarters of the year. The analyst finds out that product categories A, C and D have shown profit consistently in the east and south regions. The analyst records this finding using a note. Then, the analyst continues her analysis by studying yearly sales during stage 380 and sales distribution across regions using a map during stage 390.

Action Concepts as Context

In the products sales use example of FIG. 3, the user started her analysis with general sales data and moved on to investigate quarterly and yearly sales trends. Region was another aspect considered in the investigation. The user focused on all regions, then narrowed down to the east and south regions, and finally moved on to see the actual geographical sales distribution. She also investigated the sales of individual products as well as product categories (groups of products).

The action concepts associated with this action trail (e.g., the east region and product category) correspond to the user's information interests. However, some of the action concepts were more predominant at certain times than others. For instance, she was interested only in sales of more than $50,000 throughout the investigation. In contrast, she shifted her focus among other action concepts such as quarterly sales, product categories, and regions. Her interest in these action concepts varied over time. Therefore, during an exploration process, users' evolving information interests can be viewed as a time-varying set of weighted action concepts taken from their action trails.

A set of weighted action concepts is associated with each view and note to represent its context description. The weight for each action concept represents its degree of salience at the time the view or note was created. In one exemplary embodiment, the metrics used for calculating the weight from the action trails are motivated by the spreading-activation construct that is used in many theories for retrieving information from long term memory. See, for example, A. M. Collins and E. F. Loftus, “A Spreading-Activation Theory of Semantic Processing,” Psychological Review, 82(6):407-128 (November 1975). In these theories, knowledge is encoded as a network structure, consisting of nodes representing concepts and links representing associations among concepts. During a retrieval process, this network structure is used to identify knowledge relevant to a current focus of attention and facilitate processing of associated items. Generally, the two basic points emphasized in these theories are (1) activation is modeled as a spreading function, and (2) activation decays exponentially with the distance it spreads over a network structure.

1. Tracing Related Action Concepts

Related action concepts for a view or a note are extracted by tracing a user's action trail. A trace spreads through the branching structure of an action trail to reflect that a view or note can be created by a confluence of different lines of inquiry. Hence, (1) the direction of the trace, and (2) the trace distance for a view or note are determined.

A. Trace Direction

For a view, the related action concepts are extracted by back tracing exploration actions in an action trail. For a note, the direction of the trace is determined, that is, back trace, forward trace or both based on the type of insight behavior being performed by the user. Six types of note taking are defined based on observations of how users record notes. See, for example, Y. B. Shrinivasan and J. J. van Wijk, “Supporting the Analytical Reasoning Process in Information Visualization,” CHI '08: Proc. of the 26^{th} Annual SIGCHI Conf. on Human Factors in Computing Systems, 1237-1246 (2008).

Generally, the six types of notes are presented, as well as the direction of trace chosen to extract related action concepts for each type of notes:

Finding—Findings are usually obtained after a sequence of exploration actions. Hence, a back trace of exploration actions will give related action concepts for this note. A note with a link to a view is categorized as a finding.

Hypothesis—Users record some assertions or hypotheses that they want to confirm during an investigation. These notes influence subsequent actions. Hence, a forward trace of the exploration actions will give related action concepts for this note. A note without a link to a view is categorized as a hypothesis.

Snippet—Users can collect some relevant information from outside a visual analytics system (e.g., a snippet from the Internet). In this case, either a sequence of exploration actions might have triggered them to look for some external information or they may be preparing for an investigation by gathering some external information. Hence, in this case, both back trace and forward trace is required to derive related action concepts. A note created by copying contents from the Internet or other digital documents, and without a link to a view is categorized as a snippet.

Edit—During the exploration process, users can edit a previously recorded note. In this case, the related action concepts from the previous line of inquiry associated with the note are combined with the related action concepts from the current line of inquiry. In one implementation, only edits that add a new entity or new sentence to the notes are considered.

Reassociation—Sometimes, users can remove a link between a note and a visualization and reassociate the note to a new visualization. In this case, the related action concepts from the previous line of inquiry are replaced with those from the current line of inquiry.

Multiple Association—Some users requested multiple visualizations created at different instances during an analysis to be associated with a note. In this case, the related action concepts from the line of inquires of each visualization are combined.

B. Trace Distance

The boundary of a trace is difficult to determine algorithmically from an action trail because it depends on the semantics and is subjective. In one exemplary embodiment, a threshold is applied to deter mine the boundary: either until n unique action concepts are extracted, or when the start or end of an action trail is reached. After experimenting with various values, a threshold of n equal to 10 was employed in one implementation. Thus, the outcome of the trace is a list of related action concepts from the local neighborhood of action trails.

2. Related Action Concept Weight

Weights are derived for a set of related action concepts extracted by tracing the action trail based on the following factors:

A. Recency

Proximity of an exploration action to a view or a note in an action trail is used to weigh an action concept. dᵢ is the normalized distance of an exploration action (i) from the end of a trace for the current view or note. This normalization compensates for the variation in length for each trace. Generally, the distance in the trail 230 decays the importance.

B. Specificity

During an exploration process, analysts may focus on all values of an attribute (e.g., sales in all regions) or on specific values of those attributes (e.g., sales in the east and south regions). Hence, if an action concept references specific values within the dataset, then it is given more weight than those which reference generic characteristics. In one implementation, a specific concept is given a specificity weight s_{c} that is twice the weight of a generic concept (e.g., all regions).

Based on these factors, the weight W_{c} for an action concept c is as follows:

$${W}_{c} = {s}_{c} \times ( {w}_{b} \times {\sum }_{i = 1}^{b} {d}_{i} + {w}_{f} \times {\sum }_{i = 1}^{f} {d}_{i} ) \qquad ( 1 )$$

where s_{c} is the specificity weight of the action concept c; b and f are lengths of back and forward traces, respectively; dᵢ is the normalized distance of an exploration action (i) from the end of a trace for the current view or note; (with dᵢ=0, if c is not specified in an exploration action (i)); w_{b} and w_{f} are the weights for back and forward traces, respectively; (with w_{f}=0, for a view or a finding; w_{b}=0, for a hypothesis). For each note, related action concepts are extracted and a weight for each action concept is computed based on the structure of the user's action trail. As the exploration process evolves, the set of related action concepts for each note and their weights are updated based on the above categories.

Entities as Context

In the example of FIG. 3, the analyst recorded a note that contains entities such as product categories (A, C & D) and regions (east & south) and relationships among them. These entities and relationships also represent her information interest at the time of recording that note. Thus, entities extracted from notes also represent a user's information interest in addition to the related action concepts.

Text analysis tools are used to extract entities (e.g., people, places, and organizations) from the user's notes. See, for example, D. Ferrucci and A. Lally, “UIMA: An Architectural Approach to Unstructured Information Processing in the Corporate Research Environment, Natural Language Engineering, 10(3-4):327-348 (2004). Often, these entities are of the same types found in the dataset being visualized. An extracted entity has three properties: a type, the covered text and its canonical form. For example, a user might type ‘BOFA’ in a note to refer to ‘Bank of America’. The text analysis tool would detect this phrase as an entity of type ‘Bank’ with covered text ‘BOFA’ and canonical form ‘Bank of America’. For each type, a generic canonical form is also defined (e.g., ‘Generic Bank’) to capture general references (e.g., ‘Bank’ or Lender').

A weight can be associated with each entity extracted from a note based on its properties and frequency of occurrence (n) within the note. A weight (wₑ) is associated to the covered text e: wₑ=n, if e is a canonical form; wₑ=0.5n, if e is a type; and wₑ=0.75n, if e is a generic canonical form. Generally, a weight can be associated with each extracted entity, as is a function of the frequency (n) and specificity of the entity.

Retrieving Related Views, Notes and Concepts

A view or a note has a context description based on the related action concepts (c) from the action trails and entities (e) extracted from notes. For a given view or a note (B), a relevance score d(T) to a target view or a note from past analyses (T) can be computed as follows:

$$d ( T ) = {\sum }_{i = 1}^{m} ( {W}_{B} ( {c}_{i} ) \times {W}_{T} ( {c}_{i} ) ) + {\sum }_{i = 1}^{p} ( {w}_{B} ( {e}_{i} ) \times {w}_{T} ( {e}_{i} ) ) \qquad ( 2 )$$

where m is the number of related action concepts for the base view or note and p is the number of entities from the base note; with n=0, if B is a view; W_{T}(cᵢ)=0, when cᵢ is not a related action concept for the target view or note (T); and w_{T}(eᵢ)=0, when eᵢ is not an entity of a target note or the note attached to a target view T. Thus, a ranked list of related views and notes for a given view or note is obtained based on the context descriptions extracted from the action trails.

Next, the related concepts are derived for B. An overview of the related concepts is provided using a tag cloud 270, as shown in FIG. 2. The weights of the action concepts from the context description of B are optionally used to determine the font height for displaying each action concept in the tag cloud 270. The weight W(eᵢ) for a entity eᵢ is computed as

$$W ( {e}_{i} ) = {\sum }_{k = 1}^{n} d ( {T}_{k} ) , \qquad ( 3 )$$

where n is the number of relevant notes. d(Tₖ)=0, when the note Tₖ does not contain the entity eᵢ. The weights of the action concepts and entities are normalized before they are used to determine the font height. Entities are underlined while action concepts are not underlined in the exemplary embodiment. Since concepts can be represented in multiple words, an alternate coloring scheme can be used to distinguish concepts in the tag clouds. In the example of FIG. 3, when the analyst explores the geographic distribution of the sales during stage 390, related views and notes can be retrieved from her past analysis. Previously, she investigated sales in all regions using a tree map during step 330. This view may be one of the most relevant views for her investigation on the geographic distribution of the sales. Using the above context-based retrieval algorithm, such related views and notes are retrieved for a given view or note.

Recommending Relevant Information

The disclosed algorithm can be used to recommend related notes based on a user's ongoing exploration process. This recommendation can help the user by showing them information they may have overlooked. However, it may be important to avoid overwhelming the user with too many recommendations. According to a further aspect of the present invention, the disclosed algorithm optionally automatically recommends only the most relevant information to balance the cost of distracting their attention.

It is submitted that notes play a key role in connection discovery in visual analysis by acting as a reminder that helps to recall key aspects such as views and concepts during the foraging process. For a number of exemplary analysts, it has been found that notes act as a bridge between the analysis executed in the system and their cognitive process. The notes act as reminders to key aspects of the exploration process, such as views or concepts. Hence, in one exemplary implementation, related notes are recommended along with a thumbnail of the visualizations that led to the formulation of those notes during the exploration process.

Relationship Among Concepts and Entities

The present invention recognizes that from the navigation structure represented in the action trail 230, it is possible to identify the relationship among the action concepts. Also, the relationship among entities can be derived based on the spatial distribution of notes and text analytics as in some text analysis tools, such as Jigsaw and Entity Workspace. See, for example, J. Stasko et al., “Jigsaw: Supporting Investigative Analysis Through Interactive Visualization,” IEEE Symposium on Visual Analytics Science and Technology (2007); and/or E. Bier et al, “Entity-Based Collaboration Tools for Intelligence Analysis,” IEEE Symposium on Visual Analytics Science and Technology, 99-106 (2008). Hence, the relationship among action concepts and entities can optionally be derived from the action trails and studied using interactive graph visualization. This feature brings out the information structure that evolves during the user's exploration process and can provide an improved overview of the implicit connections among concepts during a visual analysis.

FIG. 4 is a flow chart describing an exemplary related notes recommendation process 400 incorporating features of the present invention. Generally, the related notes recommendation process 400 evaluates the relevance of each note with respect to the current action trail and ranks the notes based on a relevance score computed in accordance with Equation 2. The related notes recommendation process 400 thus recommends related notes to a user based on the context of a user's task. The user's current line of inquiry is compared to past analyses using a semantic model of the user's information interests.

The related notes recommendation process 400 constructs and maintains a per-note context model 415 represented as a weighted set of action concepts. For example, on each note change (an insight action), a context model 415 can be extracted for each altered note. Likewise, for each user action (e.g., an insight, exploration or meta action), a context model 415 can be extracted for the user's active trail 230. The set of concepts are extracted by spreading activation over the action trail 230. Each note in the context model 415 is assigned a relevance score indicating the relevance of a note's context model to the user's current information interests. As previously indicated, the importance score for each concept is a function of (i) recency (i.e., how far away along the trace was the concept found, for example, normalized to a value of [0,1], where a value of 1 is assigned for concepts in target action (e.g., 7) and a value of 0 is assigned for concepts past a given distance n (or length of trace if length<n); and (ii) specificity (i.e., whether the user interested in a generic bank versus a specific bank, each assigned a weight sⱼ (one exemplary embodiment employs values of 0.5 for generic interests and 1.0 for specific interests).

As shown in FIG. 4, the related notes recommendation process 400 initially updates the context model 415 during step 410 with the user's ongoing activity. A test is performed during step 420 to determine if the user's current activity is an insight action. If it is determined during step 420 that the user's current activity is an insight action, then the context model 435 is updated during step 430 for the new/modified note.

If, however, it is determined during step 420 that the user's current activity is not an insight action (or after the performance of step 430), then a relevance score is computed for each note during step 440. The computed relevance scores are sorted during step 450 and the most relevant notes are displayed to the user, for example, using a Top N list.

### CONCLUSION

While a number of figures show an exemplary sequence of steps, it is also an embodiment of the present invention that the sequence may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

The context-based retrieval system 100 comprises memory and a processor that can implement the processes of the present invention. Generally, the memory configures the processor to implement the visual recommendation processes described herein. The memory could be distributed or local and the processor could be distributed or singular. The memory could be implemented as an electrical, magnetic or optical memory, or any combination of these or other types of storage devices. It should be noted that each distributed processor that makes up the processor generally contains its own addressable memory space. It should also be noted that some or all of context-based retrieval system 100 can be incorporated into a personal computer, laptop computer, handheld computing device, application-specific circuit or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for recommending one or more existing notes related to a current analytic activity of a user, comprising:
recording one or more visual analytic actions performed by said user to maintain a logical record of analytic activity of said user;
generating a context model for a plurality of said existing notes, wherein said context model for a given existing note represents information interests of said user;
determining a relevance score for each of said plurality of existing notes, wherein a given relevance score characterizes a relevance of a corresponding existing note to said current analytic activity; and
recommending, in response to one or more of said visual analytic actions, one or more existing notes based on said determined relevance scores.

2. The method of claim 1, wherein said relevance score for a given existing note is based on said context model for said given existing note and a context model for said current analytic activity.

3. The method of claim 1, wherein said context model for said given existing note represents said information interests of said user at a time surrounding the point when the user recorded said corresponding existing note.

4. The method of claim 1, wherein said context model is based on a semantic model of information interests of said user.

5. The method of claim 1, wherein said context model is represented as a weighted set of action concepts.

6. The method of claim 5, wherein said relevance score is based on a specificity of said action concepts.

7. The method of claim 5, wherein said relevance score is based on a logical recency of said action concepts.

8. The method of claim 5, wherein said weighted set of action concepts is extracted from said analytic activity of said user by spreading activation over a representation of said analytic activity of said user.

9. The method of claim 5, wherein said weight W_{c} for a given action concept c is computed as follows:
$${W}_{c} = {s}_{c} \times ( {w}_{b} \times {\sum }_{i = 1}^{b} {d}_{i} + {w}_{f} \times {\sum }_{i = 1}^{f} {d}_{i} )$$
where s_{c} is a specificity weight of the action concept c; b and f are lengths of back and forward traces, respectively; w_{b} and w_{f} are weights for the forward and back traces; and dᵢ is a normalized distance of an exploration action (i) from an end of a trace for a current view or note.

10. The method of claim 9, wherein said relevance score d(T) for said existing note (T) is computed as follows:
$$d ( T ) = {\sum }_{i = 1}^{m} ( {W}_{B} ( {c}_{i} ) \times {W}_{T} ( {c}_{i} ) ) + {\sum }_{i = 1}^{p} ( {w}_{B} ( {e}_{i} ) \times {w}_{T} ( {e}_{i} ) )$$
where in is a number of related action concepts and p is a number of entities from a base note.

11. The method of claim 1, further comprising the steps of:
updating said context model of said current analytic activity after each user action;
determining said relevance score for each of said plurality of existing notes using said newly updated context model to represent said current analytic activity; and
recommending said one or more existing notes based on said determined relevance scores.

12. The method of claim 1, wherein said context model for a given existing note comprises text of said existing note.

13. A system for recommending one or more existing notes related to a current analytic activity of a user, comprising:
a memory; and
at least one processor, coupled to the memory, operative to:
record one or more visual analytic actions performed by said user to maintain a logical record of analytic activity of said user;
generate a context model for a plurality of said existing notes, wherein said context model for a given existing note represents information interests of said user;
determine a relevance score for each of said plurality of existing notes, wherein a given relevance score characterizes a relevance of a corresponding existing note to said current analytic activity; and
recommend, in response to one or more of said visual analytic actions, one or more existing notes based on said determined relevance scores.

14. An article of manufacture for recommending one or more existing notes related to a current analytic activity of a user, comprising a machine readable storage medium containing one or more programs which when executed implement the steps of:
recording one or more visual analytic actions performed by said user to maintain a logical record of analytic activity of said user;
generating a context model for a plurality of said existing notes, wherein said context model for a given existing note represents information interests of said user;
determining a relevance score for each of said plurality of existing notes, wherein a given relevance score characterizes a relevance of a corresponding existing note to said current analytic activity; and
recommending, in response to one or more of said visual analytic actions, one or more existing notes based on said determined relevance scores.

15. The article of manufacture of claim 14, wherein said relevance score for a given existing note is based on said context model for said given existing note and a context model for said current analytic activity.

16. The article of manufacture of claim 14, wherein said context model for said given existing note represents said information interests of said user at a time surrounding the point when the user recorded said corresponding existing note.

17. The article of manufacture of claim 14, wherein said context model is based on a semantic model of information interests of said user.

18. The article of manufacture of claim 14, wherein said context model is represented as a weighted set of action concepts.

19. The article of manufacture of claim 18, wherein said relevance score is based on a specificity of said action concepts.

20. The article of manufacture of claim 18, wherein said relevance score is based on a logical recency of said action concepts.

21. The article of manufacture of claim 18, wherein said weighted set of action concepts is extracted from said analytic activity of said user by spreading activation over a representation of said analytic activity of said user.

22. The article of manufacture of claim 18, wherein said weight W_{c} for a given action concept c is computed as follows:
$${W}_{c} = {s}_{c} \times ( {w}_{b} \times {\sum }_{i = 1}^{b} {d}_{i} + {w}_{f} \times {\sum }_{i = 1}^{f} {d}_{i} )$$
where s_{c} is a specificity weight of the action concept c; b and f are lengths of back and forward traces, respectively; w_{b} and w_{f} are weights for the forward and back traces; and dᵢ is a normalized distance of an exploration action (i) from an end of a trace for a current view or note.

23. The article of manufacture of claim 22, wherein said relevance score d(T) for said existing note (T) is computed as follows:
$$d ( T ) = {\sum }_{i = 1}^{m} ( {W}_{B} ( {c}_{i} ) \times {W}_{T} ( {c}_{i} ) ) + {\sum }_{i = 1}^{p} ( {w}_{B} ( {e}_{i} ) \times {w}_{T} ( {e}_{i} ) )$$
where m is a number of related action concepts and p is a number of entities from a base note.

24. The article of manufacture of claim 18, further comprising the steps of:
updating said context model of said current analytic activity after each user action;
determining said relevance score for each of said plurality of existing notes using said newly updated context model to represent said current analytic activity; and
recommending said one or more existing notes based on said determined relevance scores.

25. The article of manufacture of claim 18, wherein said context model for a given existing note comprises text of said existing note.
